(19) United States
(12) Patent Application Publication
(10) Pub. No.: US 2002/0126392 A1
(43) Pub. Date: Sep. 12, 2002

(54) Projection system utilizing asymmetric etendue

(76) Inventors: Michael Dubinovsky, Pembroke Pines, FL (US); Brian Turner, Germantown, MD (US)

Correspondence Address: FUSION LIGHTING INC, PAUL E STEINER, 7524 STANDISH PLACE, ROCKVILLE, MD, 20855

(21) Appl. No.: 10/014,808

(22) Filed: Dec. 14, 2001

Related U.S. Application Data
(60) Provisional application No. 60/255,378, filed on Dec. 15, 2000.
(60) Provisional application No. 60/263,520, filed on Jan. 24, 2001.

(51) Int. Cl. G02B 13/08; G02B 3/02; G02B 26/00

(52) U.S. Cl. 359/668; 359/720; 359/291

(57) ABSTRACT

A projection system includes a light source, a deformable micromirror device (DMD) having a plurality of mechanical mirrors which pivot about respective tilt axes, and an anamorphic optical system disposed in between the light source and the DMD along an optical path, the anamorphic optical system providing a higher magnification along a first axis and a lower magnification along a second axis orthogonal to the first axis, wherein the first axis is aligned perpendicular to the tilt axes of the mirrors. The light source may have a pre-distorted shape which corresponds to the shape of the DMD as imaged through the anamorphic optical system. For example, the light source has the shape of a parallelogram.

### BACKGROUND

1. Field of the Invention

The invention relates generally to projection displays and more specifically to a projection system which beneficially utilizes asymmetric etendue to increase throughput.

2. Related Art

Image forming devices which utilize mechanical mirrors are well known in the art. Non-limiting examples of such devices include a deformable micromirror device (DMD, also referred to as a digital micromirror device or a digital mirror device), a microelectronic mechanical system (MEMS, where a flat membrane is deformed into a mirror to focus the light, also referred to as a membrane light valve), and a grating light valve. Non-limiting examples of applications for such devices include projection displays and printers.

Anamorphic optics are also well known in the art. Such optics act on light passing therethrough in a non-uniform manner. For example, a cylindrical lens provides different magnifications in two orthogonal axes resulting in a beam which is compressed in one axis to a greater extent than the other axis.

U.S. Pat. No. 5,159,485 discloses a projection system utilizing a DMD and anamorphic optics. An anamorphic optic path is arranged such the vertical component of the light is compressed to match the physical shape of the DMD.

U.S. Pat. No. 5,796,526 also describes a projection system utilizing a DMD together with anamorphic optics. The anamorphic illumination system utilizes multiple light sources and a cylindrical lens to provide an elongated and compressed beam to the spatial light modulator (e.g. the DMD).

U.S. Pat. No. 6,147,789 discloses a projection system which utilizes a grating light valve and anamorphic optics. A laser generates line illumination using an anamorphic beam expander made of cylindrical lenses.

With reference to FIGS. 1-3, a DMD 3 includes an array of mirrors 5 with each mirror 7 corresponding to an individual pixel element on a display. Each mirror 7 is configured to tilt about an axis 9 in response to an electrical signal applied thereto. The mirrors 7 are generally square and the tilt axis 9 is typically defined by two opposite corners 9a, 9b of the mirror (See FIG. 2). For example, the mirror 7 may tilt about +/−10° with respect a plane which is perpendicular to the plane of the mirror 7 through the tilt axis 9 (See FIG. 3, with the tilt axis 9 going into the page). The projection system is configured such that one orientation of the mirror 7 corresponds to a pixel “ON” state and the other orientation of the mirror 7 corresponds to a pixel “OFF” state.

In conventional projection systems, the half beam angle of light striking the DMD is no more than the tilt angle of the mirror (e.g. a 10° half beam angle) so that light from an OFF pixel does not enter the projection lens. FIG. 4 shows a representation of a uniform beam spread 11 on the mirror 7.

U.S. Pat. No. 5,442,414 describes a DMD projection system which uses an asymmetric system aperture stop which is elongated along the pivot axis of the mirrors to take advantage of a characteristic of the mirrors where the acceptance angle for light is limited to a greater extent in the direction in which the mirrors pivot. The asymmetric aperture may be further shaped to limit light which is diffracted from the direction of pixel edges which are 45° to the mirror tilt direction. The patent indicates that the asymmetric aperture may be utilized with color systems, RGB systems, and systems using anamorphic lenses.

### SUMMARY

The following and other objects, aspects, advantages, and/or features of the invention described herein are achieved individually and in combination. The invention should not be construed as requiring two or more of such features unless expressly recited in a particular claim.

In the above-mentioned '414 patent, an asymmetric aperture functions as a physical light stop which filters the angular extent of light passing therethrough. This necessarily results in discarding light having an angular extent in excess of the cutoff along the short dimension of the asymmetric aperture. One object of the present invention is to take advantage of the asymmetric etendue characteristics of the DMD mirrors without wasting source lumens, thereby increasing system throughput.

According to one aspect of the invention, a light modulator (e.g. a DMD) is illuminated with an light beam having an non-uniform beam spread to increase the amount of useful light energy on each individual mirror element.

According to another aspect of the invention, a light source has a pre-distorted shape which maps to the shape of a target to be illuminated after passing through an anamorphic optical system.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a schematic representation of a DMD.

FIG. 2 is a schematic representation of an individual mirror element.

FIG. 3 is a schematic, cross sectional representation of an individual mirror element pivoting about its tilt axis.

FIG. 4 is a schematic, conceptual representation of a uniform beam spread on an individual mirror element.

FIG. 5 is a schematic, conceptual representation of a non-uniform beam spread on an individual mirror element, in accordance with the present invention.

FIG. 6 is a schematic representation of the relative orientation of an anamorphic optical system with respect to the tilt axes of individual mirror elements, in accordance with the present invention.

FIG. 7 is a schematic diagram illustrating the higher magnification axis of an anamorphic optical system as running perpendicular to the tilt axes.

FIG. 8 is a schematic diagram illustrating the lower magnification axis of an anamorphic optical system as running parallel to the tilt axes.

FIG. 9 is a schematic representation of the projection system with the optical path aligned normal to the mirrors.

FIG. 10 is a schematic representation of the projection system with the optical path aligned with one extreme of the tilt axes of the mirrors.

FIG. 11 is an example of the anamorphic optical system utilized together with a first prism system.

FIG. 12 is an example of the anamorphic optical system utilized together with a second prism system.

FIG. 13 is a schematic representation of a CPC with a remote aperture having a pre-compensated, distorted aperture shape.

FIG. 14 is a schematic diagram of an example projection system.

FIG. 15 is a schematic representation of a generic projection system.

FIG. 16 is a graph showing the translation of the shape of a DMD device to a distorted light source for an anamorphic optical system having a lower magnification axis running parallel to the tilt axes of the mirrors of the DMD.

FIG. 17 is a ray trace diagram for an example projection system along the higher magnification axis.

FIG. 18 is a ray trace diagram for the example projection system along the lower magnification axis.

FIG. 19 is a perspective view of an example projection system according to the present invention.

FIG. 20 is a schematic diagram of the light source and target of the projection system showing relative alignment thereof.

FIG. 21 is a schematic cross sectional view of the Sagittal (X-Z) plane of the projection system.

FIG. 22 is a schematic cross sectional view of the Meridional (Y-Z) plane of the projection system.

FIG. 23 is graph of uniformity of illumination for two cross sections of the target.

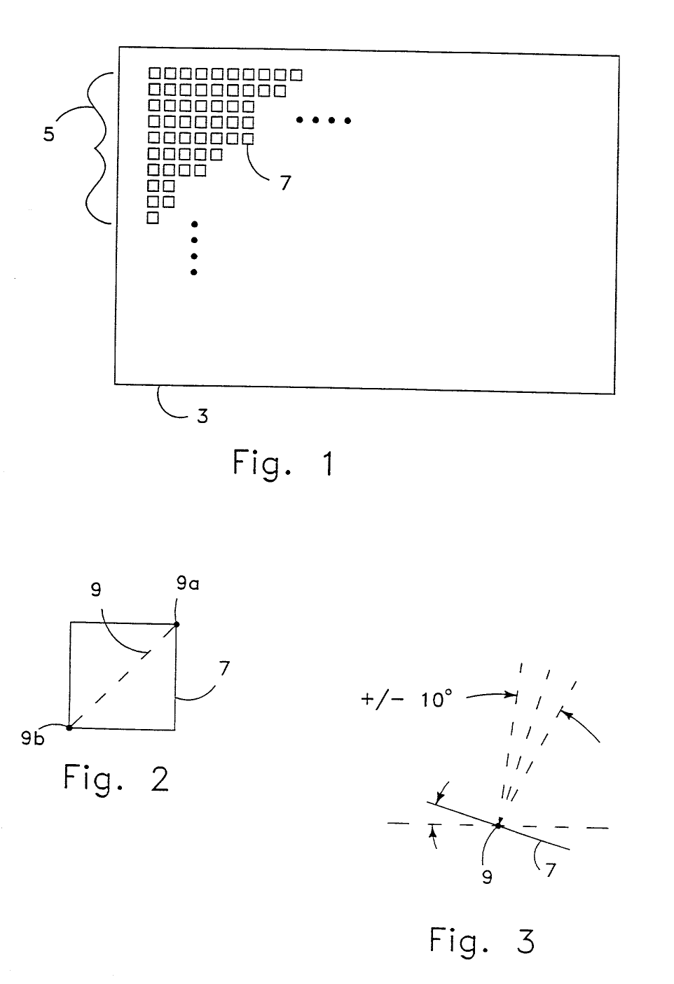

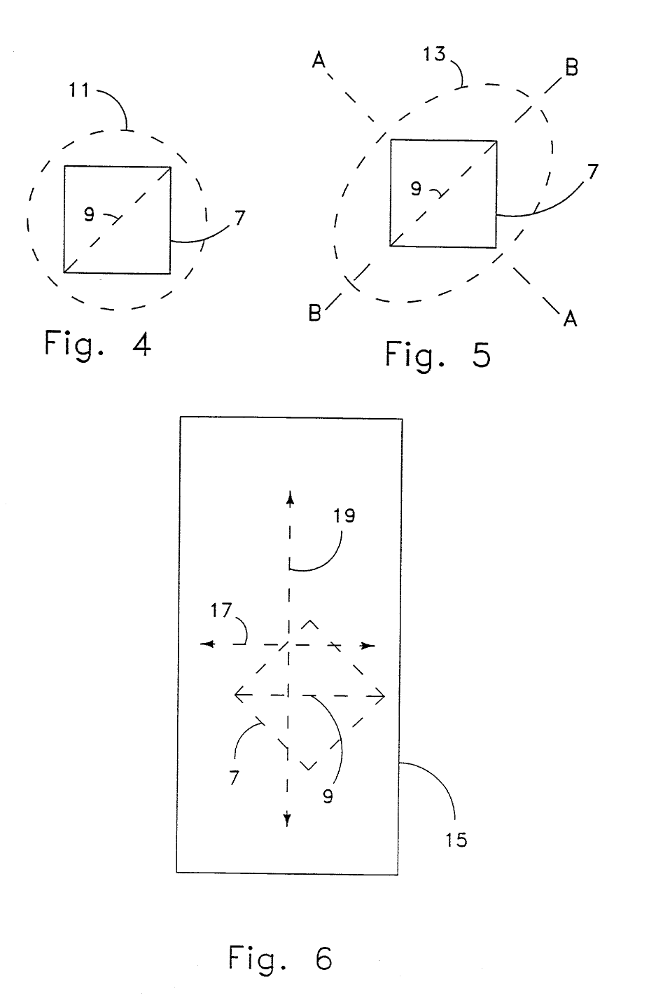

### DESCRIPTION

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

A first aspect of the invention is the utilization and orientation of an optical system configured to provide a more beneficial angular distribution of light at the light modulator (e.g. the DMD or MEMS). With reference to FIG. 5, the beam spread for a DMD is in fact limited to a greater extent along line A-A which is perpendicular to the axis of tilt 9 of the mirror 7. Along line B-B, which contains the axis of tilt 9, any beam angle is acceptable (although the beam spread along line B-B is limited in practice by the numerical aperture of the projection system). In accordance with the present invention, useful light energy on the mirror is increased by illuminating the mirror with an non-uniform beam spread 13. For example, a beam with an elliptical angular distribution having a tighter beam angle along one axis of the ellipse (e.g. along line A-A) provides a suitable non-uniform illumination (see FIG. 5).

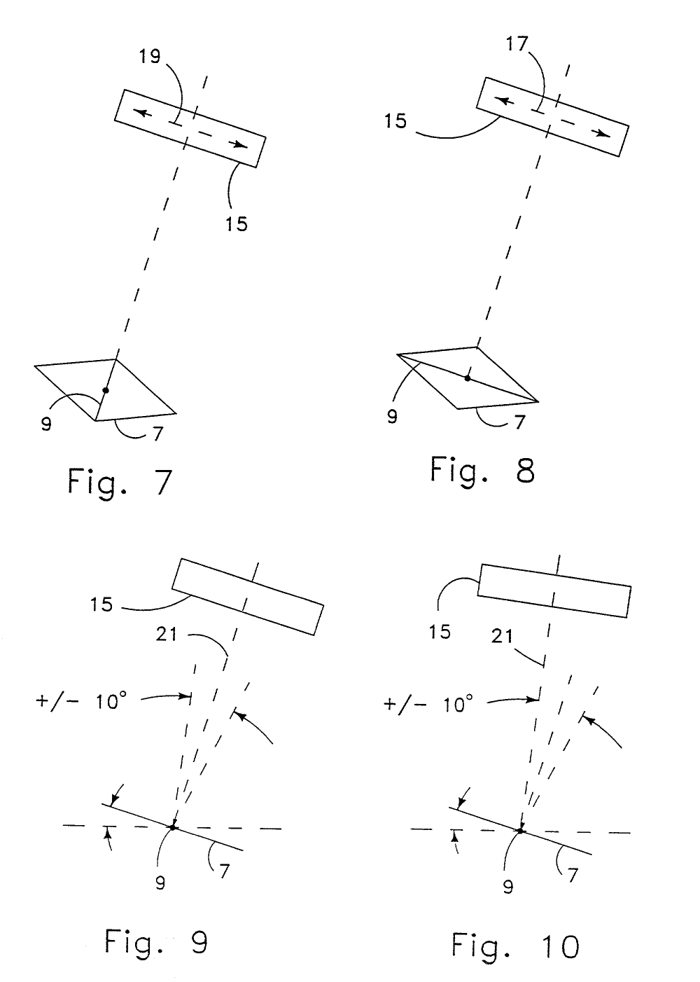

With reference to FIGS. 6-8, an anamorphic optical system 15 may be utilized to provide a desired light distribution. An anamorphic optical system acts on the light passing therethrough differently in each orthogonal axis. For example, the magnification Mx along a first axis may be different than the magnification My along the other axis (orthogonal to the first axis). Non-limiting examples of optical components providing such anamorphic characteristics include cylindrical lenses, Fresnel lenses, toroidal surfaces, gratings, gradient surfaces, and holographic surfaces. Two prisms may also be used to provide anamorphic compression (e.g. a Brewster binocular).

For example, by aligning the lower magnification axis 17 of an anamorphic optical system to be parallel with the tilt axis 9 of the mirror 7, additional useful illumination having higher angle components parallel to the tilt axis 9 (e.g. along line B-B) may be directed onto the DMD while maintaining the necessary tighter angle light on the mirror elements 7 in the axis perpendicular to the tilt axis 9 (e.g. along line A-A). The higher magnification axis 19 is perpendicular to the tilt axis. Advantageously, more source lumens may be effectively utilized because the non-uniform beam spread is achieved by angular transformation as opposed to angular filtering. Although the examples given herein are with respect to a DMD, the invention is applicable for any mechanical mirror system or other light modulator system where the beam spread is limited to a greater extent (i.e. a tighter beam acceptance angle) in one direction only, with the higher magnification axis aligned parallel with the direction in which the beam acceptance angle is tighter (e.g. a +/−10° beam acceptance angle is tighter than a +/−150 beam acceptance angle). Aperture stops within the projection system need not be asymmetric and are preferably round.

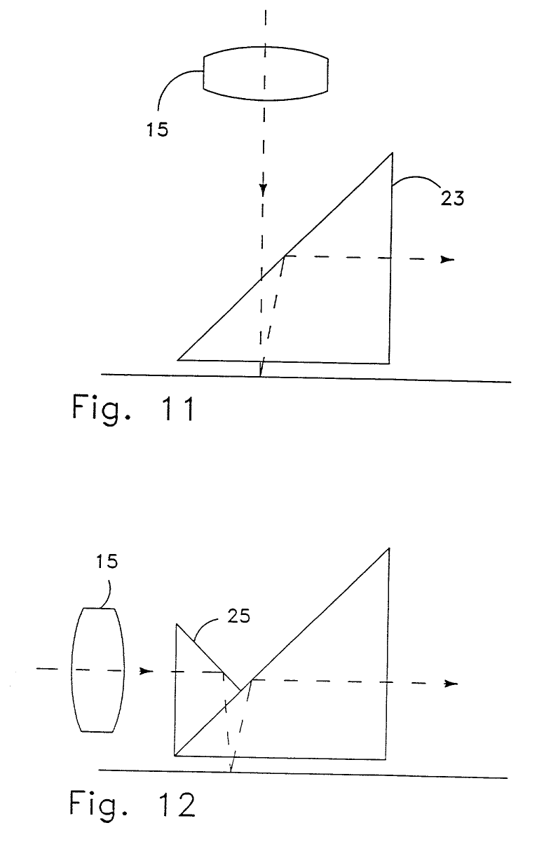

With reference to FIGS. 9-12, the anamorphic optics 15 may be positioned in the optical train at any suitable location. The optical path 21 may be normal to the mirror (see FIG. 9), at one or the other of the tilt orientations (see FIG. 10), or at some other position as may be beneficial for a particular projection application. FIGS. 11 and 12 show non-limiting examples of how the anamorphic optical system 15 may be positioned in an optical train with respect to various prism arrangements 23 and 25. The beam is uniform at the source.

Another aspect of the present invention is directed to utilizing a pre-distorted light source in combination with the anamorphic optical system to further improve the projection system performance. The shape of the light source is pre-compensated for the effects of the anamorphic system such that the DMD is fully illuminated with little waste light. For an aperture type electrodeless lamp, a pre-distorted aperture is utilized to provide the distorted source illumination. For example, the light source aperture or a remote aperture may have the pre-distorted shape.

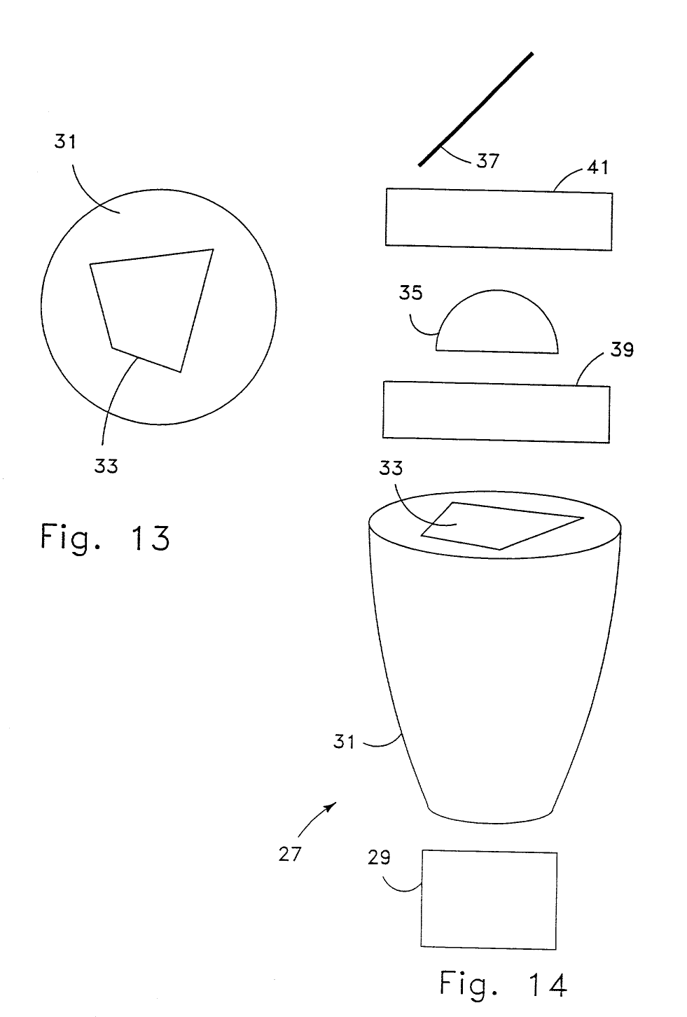

With reference to FIGS. 13-14, an example projection system 27 utilizing the present invention includes a light source 29, a CPC 31 with a remote aperture 33, the anamorphic optics 35, and the light modulator 37 (e.g. a DMD, MEMS, grating light valve, etc.) aligned along an optical path. Suitable optics 39, 41 may be disposed between the CPC 31 and the anamorphic optics 35 and also between the anamorphic optics 35 and the light modulator 37. In accordance with the present aspect of the invention, the shape of the light source 29 is configured to have a distorted shape (e.g. the remote aperture 33 on the CPC 31) before being acted on by the anamorphics optics 35. The distorted shape substantially compensates for distortion introduced into the optical path by the anamorphic optics 35 (and other downstream optical components). For example, the shape of the distorted aperture may be determined by ray tracing the outline of the light modulator 37 back through the optical system to the entrance of the anamorphic optics 35 or to the face of the CPC 31. Aperture stops (e.g. irises) in the system are typically circular. For non-aperture type lamps, a pre-distorted shape of the light source may be provided by suitable reflectors and/or optics to transform the original shape of the light source into the desired distorted shape.

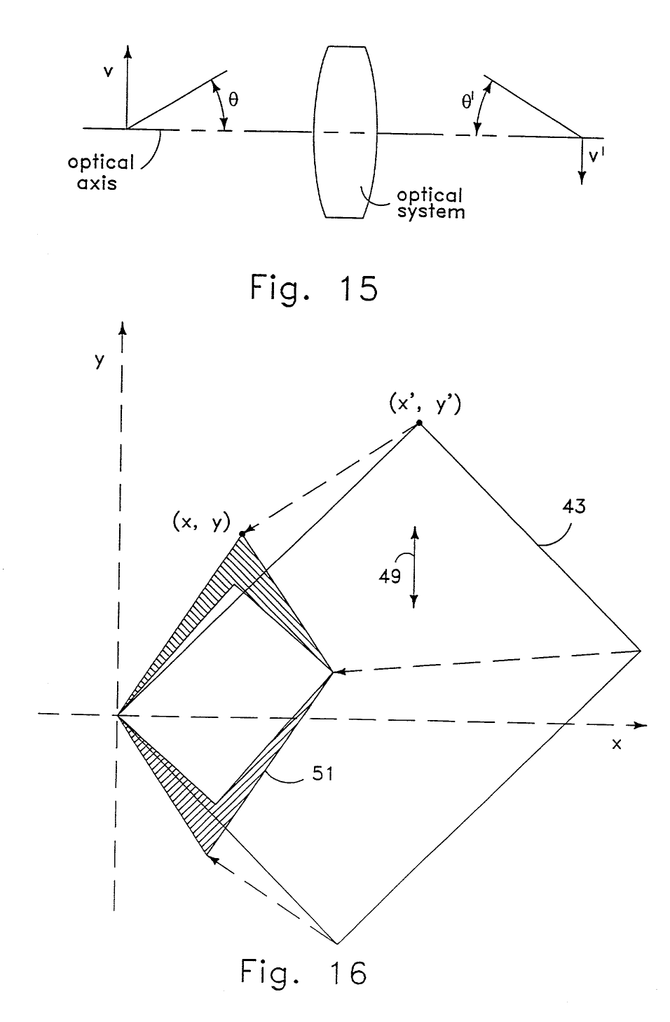

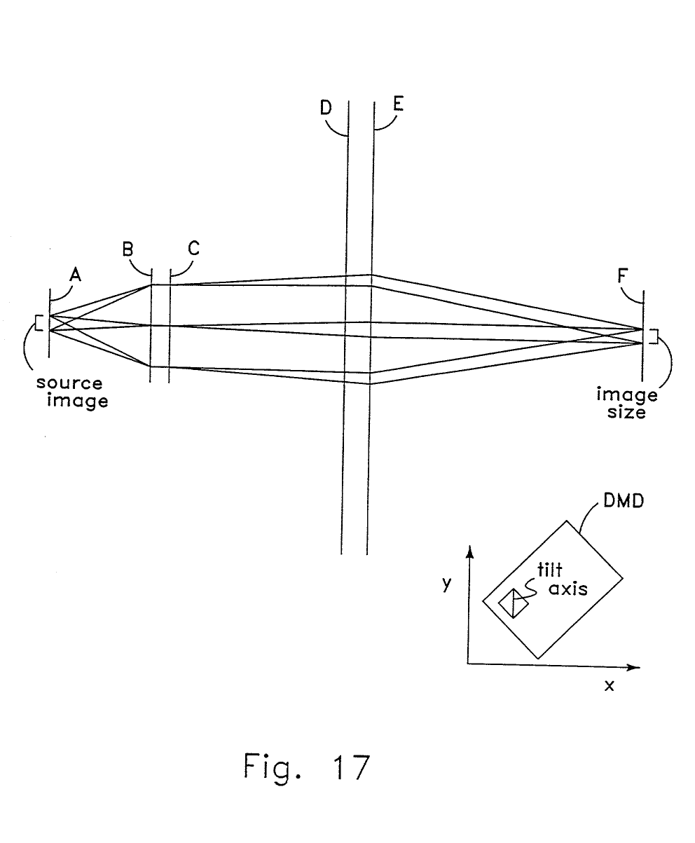

For an anamorphic optical system having two different magnifications along respective x and y axes, the shape of the distorted aperture may also be mathematically derived as follows with reference to FIGS. 15-16. FIG. 15 shows a single axis of a generic projection system where an image vector v is transformed through an optical system becoming v′ on a target. For a two axis system between a source and a target, the following optical invariant equations hold (also known as LaGrange invariant):

| Source | Target |
|---|---|
| vₓ · sin(θx) = | vₓ′ · sin(θx′) |
| v_{y} · sin(θy) = | v_{y}′ · sin(θy′) |

The magnification may be expressed as:

$$M x = \frac{V {x}^{′}}{V x} = \frac{sin ( θ x )}{sin ( θ {x}^{′} )}$$

$$M y = \frac{V {y}^{′}}{V y} = \frac{sin ( θ y )}{sin ( θ {y}^{′} )}$$

where

Vx is the source image along the x-axis

Vy is the source image along the y-axis

Vx′ is the transformed image along the x-axis

Vy′ is the transformed image along the y-axis

θx is the source half beam angle along the x-axis

θx′′is the half beam angle at the target along the x-axis

θy is the source half beam angle along the y-axis

θy′ is the half beam angle at the target along the x-axis

With reference to FIG. 16, a representative outline of a DMD 43 is positioned with an arbitrary 0, 0 point at one corner and with the tilt axis 49 of the mirrors aligned with the y-axis. With a uniform source beam angular distribution, the half beam angle is the same in both axes (θx=θy). After the anamorphic optical system, the half beam angle at the DMD 43 (θx′, θy′) is tighter along the x-axis as compared to the y-axis. For an example system, the magnification may be expressed as:

Mx=sin (25°)/sin (10°)=2.43

My=sin (25°)/sin (15°)=1.63

The shape of the distorted aperture may be determined by calculating the corresponding point (x, y) for each point (x′, y′) at the DMD 43. For an example DMD having a 3×4 ratio in arbitrary units, the various coordinates are:

| | DMD nominal point | y-axis/tilt axis | Source point |
|---|---|---|---|
| Corner | (x′, y′) | aligned point | (x, y) |
| 1 | (0, 0) | (0, 0) | (0, 0) |
| 2 | (0, −3) | (2.12, −2.12) | (0.87, −1.30) |
| 3 | (4, −3) | (4.95, 0.71) | (2.04, 0.44) |
| 4 | (4, 0) | (2.83, 2.83) | (1.16, 1.74) |

where x=x′/2.43 and y=y′/1.63 and, as noted above, the lower magnification axis (i.e. the y-axis) is aligned parallel with the tilt axis 49. The resulting distorted shape 51 for the light source (e.g. the remote aperture) is a parallelogram which is transformed from the rectangular shape of the DMD in accordance with the different magnification factors for the x and y axes. The hatched area in FIG. 16 represents additional useful illumination which may be put through the example system to improve the projection system performance.

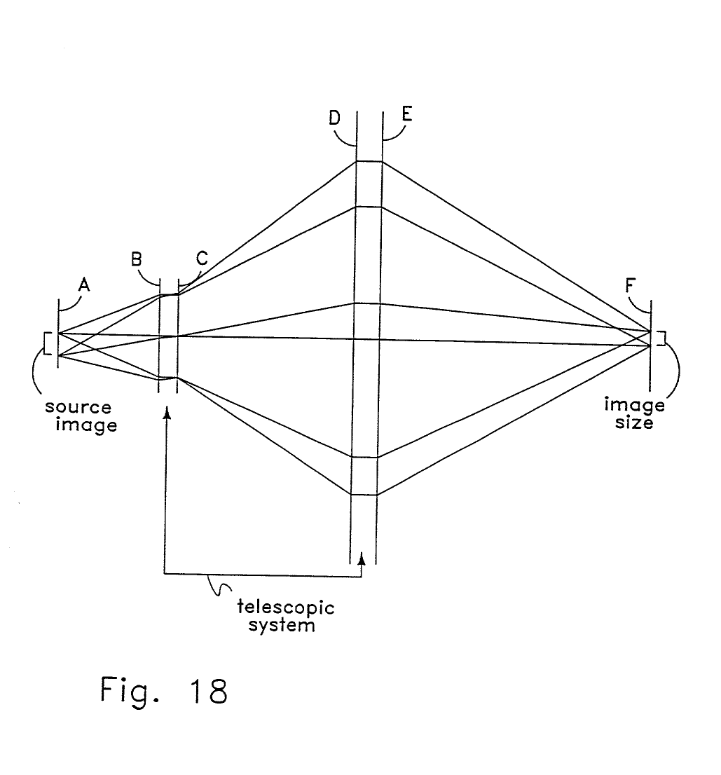

With reference to FIGS. 17 and 18, ray traces through an example optical system are shown for the x and y planes, where the y-plane is aligned parallel with the tilt axis of the DMD mirrors. The optical system components are labeled as follows:

A is the light source as presented through a remote aperture (e.g. having the parallelogram shape shown in FIG. 16);

B is a condenser lens;

C is a first cylindrical lens, which may include a circular iris at its entrance surface;

D is a second cylindrical lens;

E is a focusing lens; and

F is the image plane (e.g. the DMD).

The two cylindrical lenses C and D form an anamorphic afocal system. The optical system is configured such that a source image having a different size in the x and y-planes at the field aperture has the same image size at the target image plane.

With reference to FIG. 19, a projection system 53 includes the following components aligned along an optical train in the following order:

a light source plane 55;

a collimating lens 57;

a first cylindrical lens 59;

a second cylindrical lens 61;

a condenser lens system 63 including a pair of lenses 65 and 67; and

a target plane 69.

The two cylindrical lenses 59 and 61 form an anamorphic afocal system. The optical system is configured such that a source image having a different size in the x and y-planes at the plane of the light source 55 has the same relative image size at the target image plane 69.

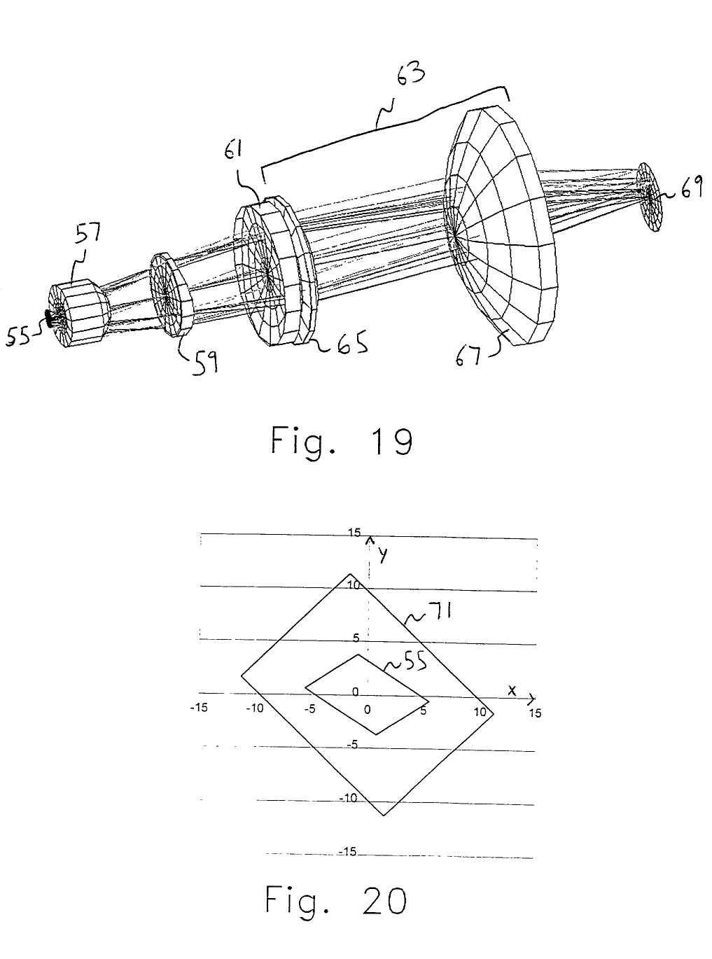

With reference to FIG. 20, the light source 55 has the shape of a parallelogram and is magnified by different amounts along the X and Y axes of the lens system to illuminate a relatively larger rectangular shape 71 at the target plane 69. For example, the parallelogram shape may be provided by a remote aperture as discussed above. For example, the rectangular shape may correspond to a particular light modulating device such as a DMD. In FIG. 20, the X and Y axes are labeled and the Z axis (which is the optical axis) goes into the page through the origin point (0, 0). For a DMD device, for example, the Y axis is the axis of lower magnification and is aligned to be parallel to the tilt axes of the mirrors of the DMD.

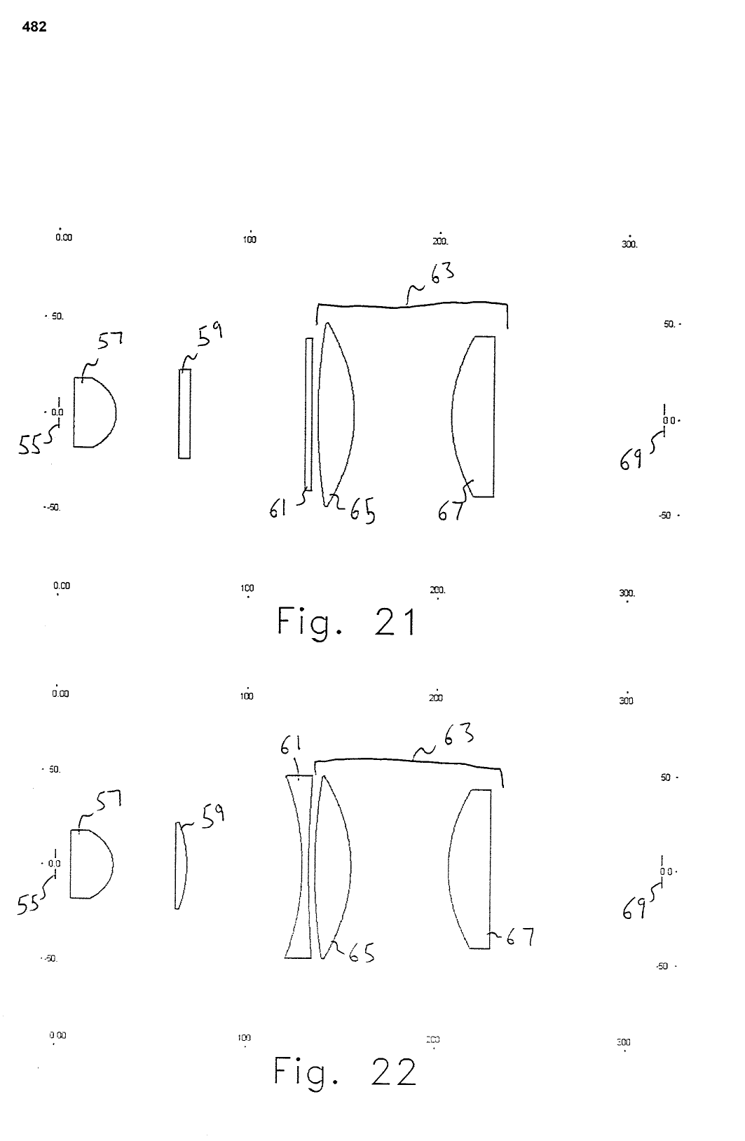

With reference to FIGS. 21-22, the X and Y planes of the lens system are respectively shown in cross section, with the Z axis coincident with the optical axis in both figures. As shown in FIG. 21, the x axis is the axis of higher magnification and the two cylindrical lenses 9 and 11 are uniform in cross section. As shown in FIG. 22, the y axis is the axis of lower magnification and the cylindrical lenses 59 and 61 have curved cross sections. The lens system may be simulated using the Zemax Optical Design Program commercially available from Focus Software, Inc. of Tucson, Ariz. The specification for the lenses as a Surface Data Summary are as follows:

| Surface | Type | Radius | Thickness | Glass | Diameter | Conic |
|---|---|---|---|---|---|---|
| OBJ | standard | infinity | 4.50 | | 6.65 | 0 |
| 1 | standard | infinity | 17.77 | BK7 | 12.73 | 0 |
| 2 | standard | −11.98 | 21.08 | | 22.08 | −0.3595 |
| STO | standard | infinity | 4.53 | BK7 | 28.20 | 0 |
| 4 | toroidal | −45.01 | 33.50 | | 29.77 | 0 |
| 5 | toroidal | −100.24 | 2.72 | BK7 | 49.21 | 0 |
| 6 | toroidal | 210.84 | 1.87 | | 50.23 | 0 |
| 7 | standard | 215.79 | 10.64 | BK7 | 52.23 | 0 |
| 8 | standard | −49.42 | 54.94 | | 52.80 | −1 |
| 9 | standard | 54.96 | 22.00 | BK7 | 84.00 | −1 |
| 10 | standard | infinity | 50.80 | | 84.00 | 0 |
| IMA | standard | infinity | — | | 24.00 | 0 |

The object space numerical aperture (Obj. Space N.A.) is 0.5736.

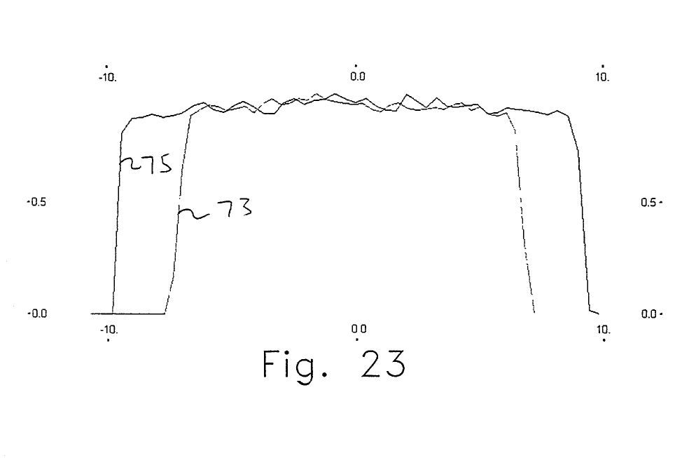

With reference to FIG. 23, simulation results illustrated as a first cross section 73 taken perpendicular to the long side of the rectangular shaped target 71 and a second cross section 75 taken perpendicular to the short side of the target 71 show good uniformity of illumination over the illuminated rectangle 71 on the target plane 69.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. A projection system, comprising:
a light source;
a light modulator having a beam acceptance angle which is tighter in one direction; and
an anamorphic optical system disposed between the light source and the light modulator along an optical path, the anamorphic optical system providing a higher magnification along a first axis and a lower magnification along a second axis orthogonal to the first axis,
wherein the second axis is aligned transverse to the direction in which the beam acceptance angle is tighter.

2. The projection system as recited in claim 1, wherein the light source has a pre-distorted shape which corresponds to the shape of the light modulator as imaged through the anamorphic optical system.

3. The projection system as recited in claim 1, wherein the second axis is aligned perpendicular to the direction in which the beam acceptance angle is tighter.

4. A projection system, comprising:
a light source;
a deformable micromirror device (DMD) having a plurality of mechanical mirrors which pivot about respective tilt axes;
an anamorphic optical system disposed in between the light source and the DMD along an optical path, the anamorphic optical system providing a higher magnification along a first axis and a lower magnification along a second axis orthogonal to the first axis,
wherein the first axis is aligned perpendicular to the tilt axes of the mirrors.

5. The projection system as recited in claim 4, wherein the light source has a pre-distorted shape which corresponds to the shape of the DMD as imaged through the anamorphic optical system.

6. The projection system as recited in claim 5, wherein the light source has the shape of a parallelogram.

7. A projection system, comprising:
a light source having a parallelogram cross sectional beam shape perpendicular to the optical axis;
a light modulator; and
an optical system disposed between the light source and the light modulator.
